(19) United States
(12) Patent Application Publication
(10) Pub. No.: US 2019/0007913 A1
(43) Pub. Date: Jan. 3, 2019

(54) Multi-Subscriber Identity Module User Equipment and Re-Synchronizing Method Thereof

(71) Applicant: MEDIATEK INC., Hsinchu (TW)

(72) Inventors: Chih-Yuan Tsai, New Taipei City (TW); Shu-Hao Yeh, New Taipei City (TW); Zong-Syun Lin, Kaohsiung City (TW); Yun-Hsuan Chang, Zhubei City (TW)

(21) Appl. No.: 15/640,653

(22) Filed: Jul. 3, 2017

(51) Int. Cl. H04W 56/00; H04W 76/02

(52) U.S. Cl. CPC H04W 56/001; H04W 88/06; H04W 76/025

(57) ABSTRACT

A dual SIM user equipment and a re-synchronizing method thereof are provided. The dual SIM user equipment includes a single radio frequency module, a first SIM and a second SIM. The first SIM connects with a first network via utilizing the single radio frequency module at first. The second SIM then connects with a second network via utilizing the single radio frequency module. The first SIM monitors the second SIM for determining that the second SIM disconnects from the second network. The first SIM then transmits a synchronization information to the first network for re-synchronizing to the first network while the first SIM determines that there is no data to be transmitted to the first network.

### CROSS-REFERENCES TO RELATED APPLICATIONS

Not applicable.

### BACKGROUND OF THE INVENTION

### Field of the Invention

The invention generally relates to a Multi-SIM user equipment technology; and more particularly, relates to a re-synchronizing method thereof for re-synchronizing to wireless network.

### Descriptions of the Related Art

Wireless communication systems have been widely deployed to provide various telecommunication services such as telephony, video, data, messaging, and broadcast. Typical wireless communication systems may employ multiple-access technologies capable of supporting communication with multiple users by sharing available system resources (e.g., bandwidth, transmission power).

Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE) which is a set of enhancements to the Universal Mobile Telecommunication System (UMTS) mobile standard promulgated by the Third Generation Partnership Project (3GPP). It is designed to better support mobile broadband Internet access by improving spectral efficiency, lowering costs, improving services, making use of new spectrums, and integrating better with other open standards using OFDMA on downlinks (DL), and SC-FDMA on uplinks (UL) and multiple-input multiple-output (MIMO) antenna technology.

A Multi-SIM wireless communication device may be one which holds two SIM cards, which means that the device can handle two different network services. Each network service can be assigned to a different account or telephone number. In wireless devices that include only one transceiver, only one of the two subscriptions may be transmitting or receiving radio frequency (RF) signals at a time. Such devices are referred to as Dual SIM Dual Standby (DSDS) devices, since while one service is actively transmitting or receiving the other service is put on standby.

In a traditional DSDS device, state synchronization between one SIM and the corresponding network may be failed while the existed connection is interrupted by another SIM to set up the connection with corresponding network. For example, a user equipment has a first SIM and a second SIM, and the first SIM establishes connection with a network and enter connected state via a radio frequency module of the user equipment first.

Then, when the second SIM is triggered for a communication procedure with higher priority (e.g., mobile originated call) and needs to occupy the only radio frequency module to establish the connection with the corresponding network, the first SIM then disconnects from the network without any notification to release the control of the only radio frequency module to the second SIM. The network corresponded to first SIM is only aware of that the first SIM is no longer in connecting state until observing no data is transmitted from the first SIM for a period (e.g., inactivity timer in LTE). In other words, the state of first SIM and the corresponding network is not synchronized during this observation period.

During the mentioned period, after the second SIM finishes the communication procedure and both the first and the second SIM go back to idle mode to listen to idle paging message, and before the corresponding network detects the first SIM is no longer in connected state, if there is a Mobile Terminated (MT) call to the first SIM, the corresponding network transmits, to the first SIM, a circuit switched (CS) service notification messages (e.g., circuit switch fallback call, CSFB call) or Session Initiation Protocol (SIP) message (e.g., Voice over LTE call, VoLTE call) instead of idle paging. Hence, MT call to the first SIM may be missed during the mentioned period.

Accordingly, an urgent need exists in the art to improve the shortcomings of the conventional dual SIM technology so as to avoid missing MT call.

### SUMMARY OF THE INVENTION

The primary objective of this invention is to provide a re-synchronizing method for use in a multi-subscriber identity module (SIM) user equipment. The user equipment may have a single radio frequency module, a first SIM and a second SIM. The first SIM connects with a first network via utilizing the single radio frequency module. The re-synchronizing method comprises: (a) interrupting, by the second SIM, the first connection of the first SIM via procedure of establishing a second connection with a second network for releasing the control of single radio frequency module, wherein priority of the second connection is higher than priority of the first connection; (b) establishing, by the second SIM, the second connection with a second network for a communication procedure by utilizing the single radio frequency module; (c) monitoring, by the first SIM, the second SIM for determining that the second SIM finishes the communication procedure and releases the second connection with the second network; (d) initialing, by the first SIM, a synchronization procedure with the first network after step (c) for re-synchronizing to the first network while the first SIM determines that there is no data to be transmitted to the first network.

Another objective of this invention is to provide a multi SIM user equipment which comprises a single radio frequency module, a first SIM and s second SIM. The first SIM connects with a first network via a first connection by utilizing the single radio frequency module at first. Afterwards, the second SIM: interrupts the first connection of the first SIM via procedure of establishing a second connection with a second network for releasing the control of single radio frequency module, wherein priority of the second connection is higher than priority of the first connection; establishes the second connection with the second network for a communication procedure by utilizing the single radio frequency module. The first SIM: monitors the second SIM for determining that the second SIM finishes the communication procedure with the second network and releases the second connection with the second network; initials a synchronization procedure with the first network for re-synchronizing to the first network while the first SIM determines that there is no data to be transmitted to the first network.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of an communication network system according to a first embodiment of the present invention;

FIG. 1B is a schematic views of status of the SIMs during the connections according to the first embodiment of the present invention; and

FIG. 2 is a flowchart diagram of a re-synchronizing method according to a second embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. In the following embodiments and the attached drawings, elements unrelated to the present invention are omitted from depiction; and dimensional relationships among individual elements in the attached drawings are illustrated only for ease of understanding, but not to limit the actual scale.

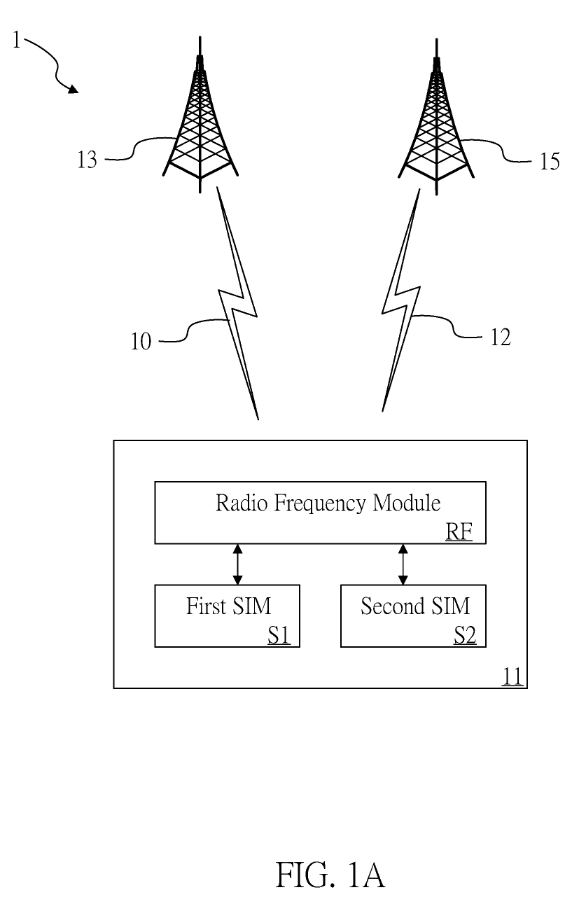

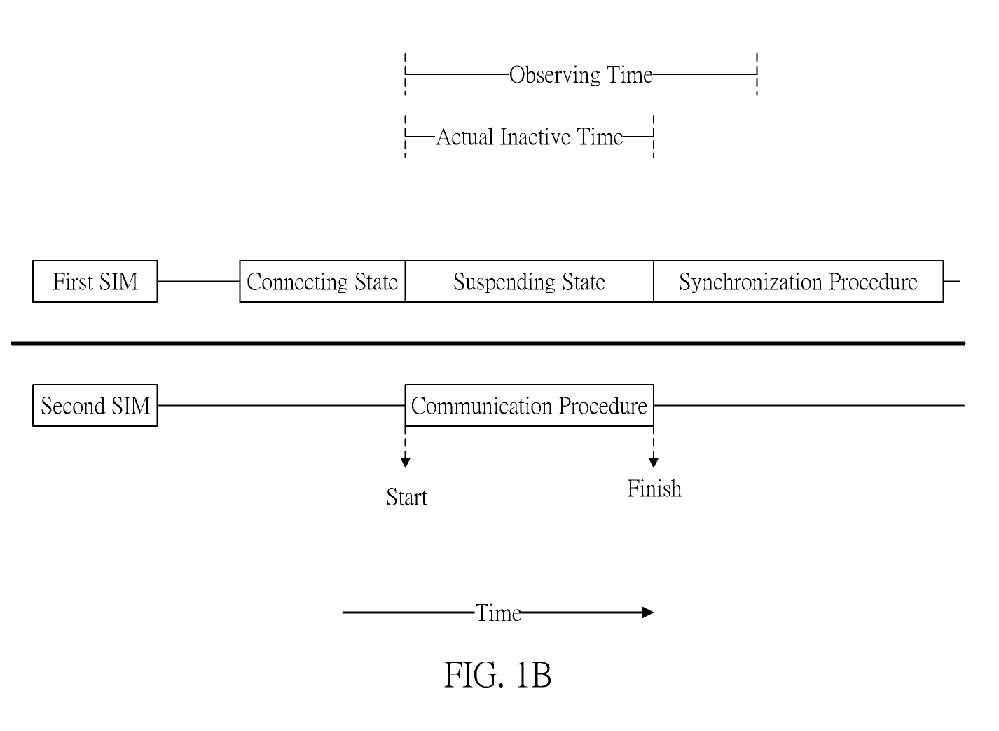

Please refer to FIGS. 1A-1B. FIG. 1A is a schematic views of a communication network system 1 according to a first embodiment of the present invention. The communication network system 1 comprises a multiple subscriber identity module (SIM) user equipment 11, a first network 13 and a second network 15. The multiple SIM user equipment 11 may comprise a single radio frequency module RF, a first SIM S1 and a second SIM S2. FIG. 1B is a schematic views of status of the SIMs S1 and S2 during the connections according to the first embodiment of the present invention. Interactions between the elements thereof will be further described hereinbelow.

Particularly, in the first embodiment, the first SIM S1 connects with the first network 13 (connecting state in FIG. 1B) via a first connection 10 by utilizing the single radio frequency module RF at the beginning. Then, when the second SIM S2 is triggered for a communication procedure with higher priority, the second SIM S2 interrupts the first connection 10 of the first SIM S1 via procedure of establishing a second connection 12 with the second network 15 for releasing the control of single radio frequency module RF.

It should be noted that, priority of the second connection 12 is higher than priority of the first connection 10. In other words, priority of establishing the second connection 12 with the second network 15 is higher than current procedure of the first connection 10 so that the first connection 10 of the first SIM S1 is interrupted and the control of single radio frequency module RF is released.

After the interruption, the second SIM S2 directly establishes the second connection 12 with the second network 15 for a communication procedure (not shown) by utilizing the single radio frequency module RF. Accordingly, the first SIM S1 suspends (suspending state in FIG. 1B) and disconnects from the first network 13 without any notification so that the first network 13 expects that the first connection 10 with the first SIM S1 is still existed.

Therefore, the first network 13 waits data transmission of the first SIM S1 and plans to keep transmitting a circuit switched (CS) service notification messages (e.g., circuit switch fallback call, CSFB call) or Session Initiation Protocol (SIP) message (e.g., Voice over LTE call, VoLTE call) instead of idle paging message if there is a mobile terminated (MT) call to the first SIM S1 during On observing time (e.g., inactivity time in LTE).

Afterwards, during the communication procedure between the second SIM S2 and the second network 15, the first SIM S1 monitors the second SIM S2 for determining what time does the second SIM S2 finish the communication procedure and release the second connection 12. Then, after determining that the second SIM S2 finishes the communication procedure and releases the second connection 12 with the second network 15, the first SIM S1 takes back the control of the single radio frequency module RF for later use.

Next, if the first SIM S1 determines that there is no further data to be transmitted to the first network 13 without notifying the first network 13, the first network 13 keeps wasting network resources for transmitting CS service notification message or SIP message to the first SIM S1 during the observing time. Accordingly, in the present embodiment, after determining that the second SIM S2 finishes the communication procedure with the second network 15 and there is no further data to be transmitted to the first network 13, the first SIM S1 actively initials a synchronization procedure with the first network 13 for re-synchronizing the first SIM S1 state to the first network 13.

More specifically, even if the first SIM S1 has no data to be transmitted to the first network 13 after monitoring that the second SIM S2 finishes the communication procedure, the first SIM S1 still initials the synchronization procedure with the first network 13 actively for notifying the first network 13 of: (1) ceasing to transmit useless CS service notification messages or SIP messages; and (2) starting to transmit useful idle paging signals. Therefore, the first SIM S1 is capable of re-synchronizing to the first network 13 earlier within the observing time (i.e., the first SIM S1 is capable of re-synchronizing to the first network 13 right after actual inactive time finishes) of the first network 13 for avoiding failing paging during the observing time.

It should be noted that, in the first embodiment, the communication network system 1 may be a Long Tern Evolution (LTE) system, and the networks 13 and 15 comprise operators for the SIMs to connect. The people skilled in the art should easily understand that the networks can be operated by the same operator or by the respective operators. Moreover, multi SIM user equipment 11 may comprise more than two SIMs in different embodiments.

Furthermore, in other embodiments, the second SIM S2 may establish the second connection 12 with the second network 15 for a mobile originated (MO) call, a mobile terminated (MT) call or a location area update (LAU) procedure. The synchronization procedure may further comprise a tracking area updating (TAU) signal, and then the first SIM S1 re-synchronizes with the first network 13 via TAU procedure. However, it is not intended to limit the present invention to any specific environment, applications or particular implementations described in the embodiment.

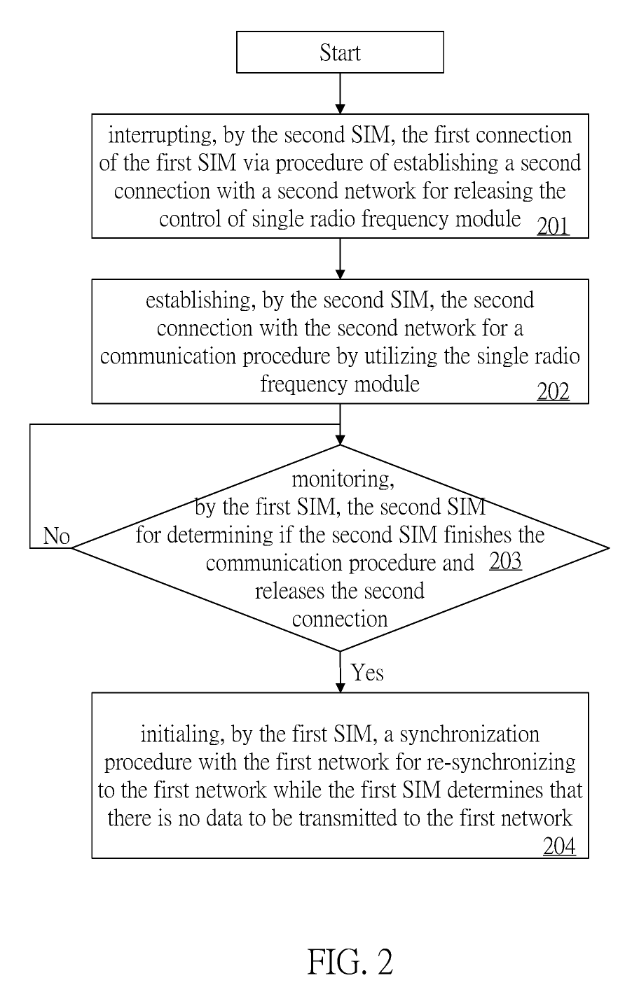

A second embodiment of the present invention is a re-synchronizing method, a flowchart diagram of which is shown in FIG. 2. The method of the second embodiment is for use in an multiple SIM user equipment (e.g., the multiple SIM user equipment of a previous embodiment). The multiple SIM user equipment comprises a single radio frequency module, a first SIM and a second SIM. The first SIM connects with a first network at first via a first connection by utilizing the single radio frequency module. Detailed steps of the second embodiment are described as follows.

Firstly, when the second SIM is triggered for a communication procedure with higher priority, step 201 is executed to interrupt, by the second SIM, the first connection of the first SIM via procedure of establishing a second connection with the second network for releasing the control of single radio frequency module. It should be noted that the interruption happens since priority of the second connection is higher than priority of the first connection.

Next, step 202 is executed to establish, by the second SIM, the second connection with the second network for a communication procedure by utilizing the single radio frequency module. Accordingly, the first SIM disconnects from the first network without any notification so that the first network expects that the connection with the first SIM is still existed. Therefore, the first network waits data transmission of the first SIM and plans to keep transmitting CS service notification messages (e.g., circuit switch fallback call, CSFB call) or SIP message (e.g., Voice over LTE call, VoLTE call) instead of idle paging message if there is an MT call to the first SIM during a observing time (e.g., inactivity time in LTE).

Then, during the communication procedure between the second SIM and the second network, step 203 is executed to monitor, by the first SIM, the second SIM for determining if the second SIM finishes the communication procedure and releases the second connection. If no, step 203 is executed repeatedly. If yes, the first SIM takes back the control of the radio frequency module, and step 204 is executed to initial, by the first SIM, a synchronization procedure with the first network after step 203 for re-synchronizing to the first network while the first SIM determines that there is no data to be transmitted to the first network.

It should be noted again that, similarly, even if the first SIM has no data to be transmitted to the first network after monitoring that the second SIM finishes the communication procedure, step 204 is executed by the first SIM to initial the synchronization procedure with the first network actively for notifying the first network of: (1) ceasing to transmit useless CS service notification messages or SI messages; and (2) starting to transmit useful idle paging signals. Therefore, the first SIM is capable of re-synchronizing to the first network earlier within the observing time of the first network for avoiding failing paging during the observing time.

According to the above descriptions, the dual SIM user equipment and the re-synchronizing method thereof according to the present invention can actively start synchronization procedure to the first network after the switch between the SIMs. Thereby, an improvement can be made on the shortcomings of the conventional dual SIM user equipment technologies to avoid failing paging procedure between the network and the SIM.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A re-synchronizing method for use in a multi subscriber identity module (SIM) user equipment which comprises a single radio frequency module, a first SIM and a second SIM, the first SIM connecting with a first network via a first connection by utilizing the single radio frequency module, the re-synchronizing method comprising:
(a) interrupting, by the second SIM, the first connection of the first SIM via procedure of establishing a second connection with a second network for releasing the control of single radio frequency module, wherein priority of the second connection is higher than priority of the first connection;
(b) establishing, by the second SIM, the second connection with the second network for a communication procedure by utilizing the single radio frequency module;
(c) monitoring, by the first SIM, the second SIM for determining that the second SIM finishes the communication procedure with the second network and release the second connection with the second network;
(d) initialing, by the first SIM, a synchronization procedure with the first network after step (c) for re-synchronizing to the first network while the first SIM determines that there is no data to be transmitted to the first network.

2. The re-synchronizing method of claim 1, wherein the synchronization procedure is a tracking area updating signal procedure.

3. The re-synchronizing method of claim 1, wherein the second SIM establishes the second connection with the second network for a location area update procedure.

4. The re-synchronizing method of claim 1, wherein the second SIM establishes the second connection with the second network for a mobile originated call.

5. The re-synchronizing method of claim 1, wherein the second SIM establishes the second connection with the second network for a mobile terminated call.

6. A multi subscriber identity module (SIM) user equipment, comprising:
a single radio frequency module;
a first SIM, connecting with a first network via a first connection by utilizing the single radio frequency module; and
a second SIM;
wherein the second SIM:
interrupts the first connection of the first SIM via procedure of establishing a second connection with a second network for releasing the control of single radio frequency module, wherein priority of the second connection is higher than priority of the first connection;
establishes the second connection with the second network for a communication procedure by utilizing the single radio frequency module;
wherein the first SIM:
monitors the second SIM for determining that the second SIM finishes the communication procedure with the second network and releases the second connection with the second network;
initials a synchronization procedure with the first network for re-synchronizing to the first network while the first SIM determines that there is no data to be transmitted to the first network.

7. The multi SIM user equipment of claim 6, wherein the synchronization procedure is a tracking area updating signal procedure.

8. The multi SIM user equipment of claim 6, wherein the second SIM establishes the second connection with the second network for a location area update procedure.

9. The multi SIM user equipment of claim 6, wherein the second SIM establishes the second connection with the second network for a mobile originated call.

10. The multi SIM user equipment of claim 6, wherein the second SIM establishes the second connection with the second network for a mobile terminated call.
